(19) United States
(12) Patent Application Publication
(10) Pub. No.: US 2008/0047389 A1
(43) Pub. Date: Feb. 28, 2008

(54) FOOT PEG ASSEMBLY FOR A MOTORCYCLE

(75) Inventors: John W. LeClaire, Brookfield, WI (US); Kenneth A. Dietzler, Milwaukee, WI (US); Nelson J. Cobb, Palmyra, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/466,799

(22) Filed: Aug. 24, 2006

(51) Int. Cl. G05G 1/18

(52) U.S. Cl. 74/564

(57) ABSTRACT

A foot peg assembly for use with a motorcycle. The foot peg assembly includes a mount and a foot pad. The mount is adapted to be coupled to the motorcycle, and the foot pad is supported by the mount. The foot pad is made from a first material and includes a cavity formed therein, and a second material in the cavity that is viscoelastic and different from the first material.

### BACKGROUND

The present invention relates to foot peg assemblies for motorcycles, and more particularly to foot peg assemblies configured to dampen motorcycle vibrations through foot pads.

Motorcycles typically include a foot peg or a foot board located on each side of the motorcycle such that a rider of the motorcycle can rest their feet on the foot pegs or the foot boards. Often the motorcycle can support a second rider, or passenger, and the motorcycle further includes a second set of foot boards or foot pegs for the passenger. The foot pegs or foot boards can each include a foot pad made from an elastomeric material, such as rubber. The foot pad is coupled to a body of the foot peg, and the rider's or passenger's feet rest on the foot pad to cushion the foot and dampen motorcycle vibrations.

### SUMMARY

In one embodiment, the invention provides a foot peg assembly for use with a motorcycle. The foot peg assembly includes a mount adapted to be coupled to the motorcycle, and a foot pad supported by the mount. The foot pad is made from a first material and includes a cavity formed therein, and a second material in the cavity that is viscoelastic and different from the first material.

In another embodiment, the invention provides a foot peg assembly for use with a motorcycle. The foot peg includes a mount adapted to be coupled to the motorcycle, and a foot pad supported by the mount. The foot pad is selectively adjustable between a first position corresponding with a first damping characteristic and a second position corresponding with a second damping characteristic different than the first damping characteristic.

In yet another embodiment, the invention provides a method of using a foot peg for a motorcycle. The foot peg has a foot pad and a mount. The method includes generating vibrations with the motorcycle, and resting a foot of a rider of the motorcycle on the foot pad. The method further includes damping the motorcycle vibrations with the foot pad exhibiting a first damping characteristic, and transferring a first amount of damped vibrations through the foot pad exhibiting the first damping characteristic to the foot. The method further includes adjusting the foot pad to exhibit a second damping characteristic different from the first damping characteristic, and damping the motorcycle vibrations with the foot pad exhibiting the second damping characteristic. The method further includes transferring a second amount of damped vibrations through the foot pad exhibiting the second damping characteristic to the foot.

Other aspects of the invention will become apparent by consideration of the detailed description and accompanying drawings.

### BRIEF DESCRIPTION OF THE DRAWINGS

FIG. 1 is a perspective view of a motorcycle employing foot peg assemblies embodying the present invention.

FIG. 2 is an exploded view of one of the foot peg assemblies of FIG. 1.

FIG. 3 is another exploded view of the foot peg assembly of FIG. 2.

FIG. 4 is a perspective view of the foot peg assembly of FIG. 2 showing the foot peg assembly assembled.

FIG. 5 is a cross-sectional view taken along line 5-5 of FIG. 3 with cross-hatching removed for clarity.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

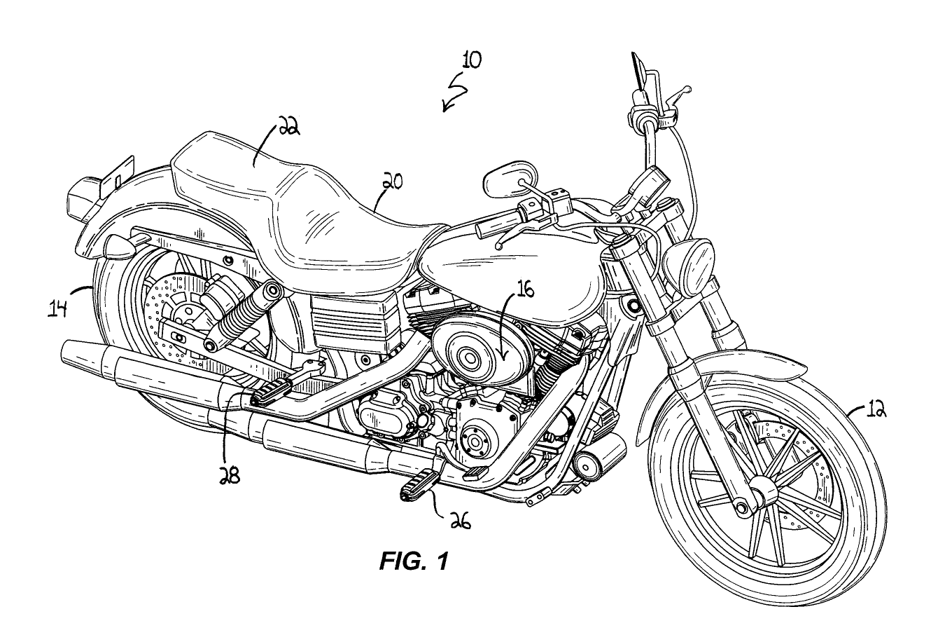

FIG. 1 illustrates a motorcycle 10 that includes a front wheel 12, a rear wheel 14, and an engine 16 that is configured to drive the rear wheel 14. The motorcycle 10 further includes a seat 20 that supports a rider or operator of the motorcycle 10. The illustrated seat 20 includes a passenger portion 22 that can support a second rider or passenger.

A first foot peg assembly 26 is located below the seat 20, so that the operator of the motorcycle 10 can rest their foot on the first foot peg assembly 26. A second foot peg assembly 28 is located behind the first foot peg assembly 26, so that the passenger can rest their foot on the second foot peg assembly 28. While only one side of the motorcycle 10 is illustrated in FIG. 1, it should be understood that the opposite side of the motorcycle 10 includes mirror-image foot peg assemblies in the same relative position as the first and second foot peg assemblies 26, 28.

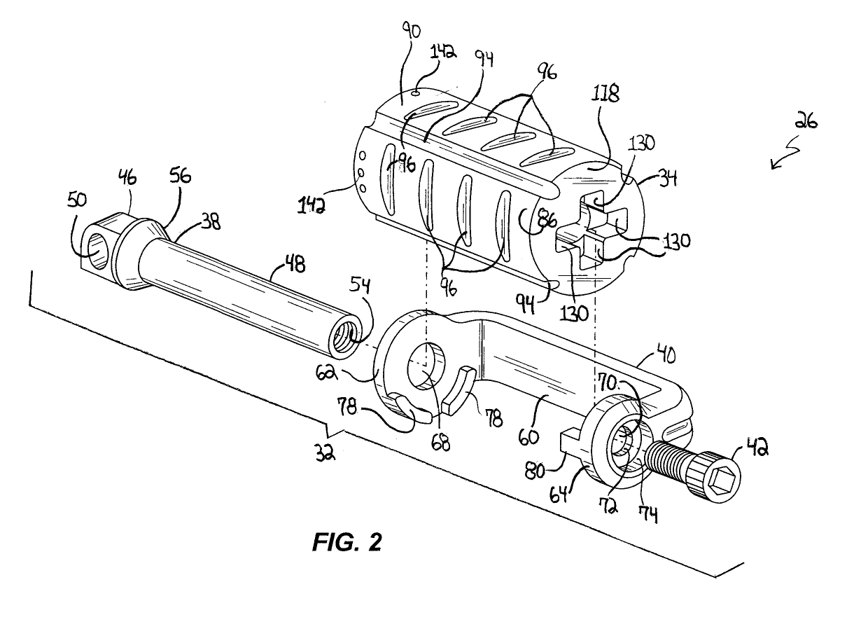

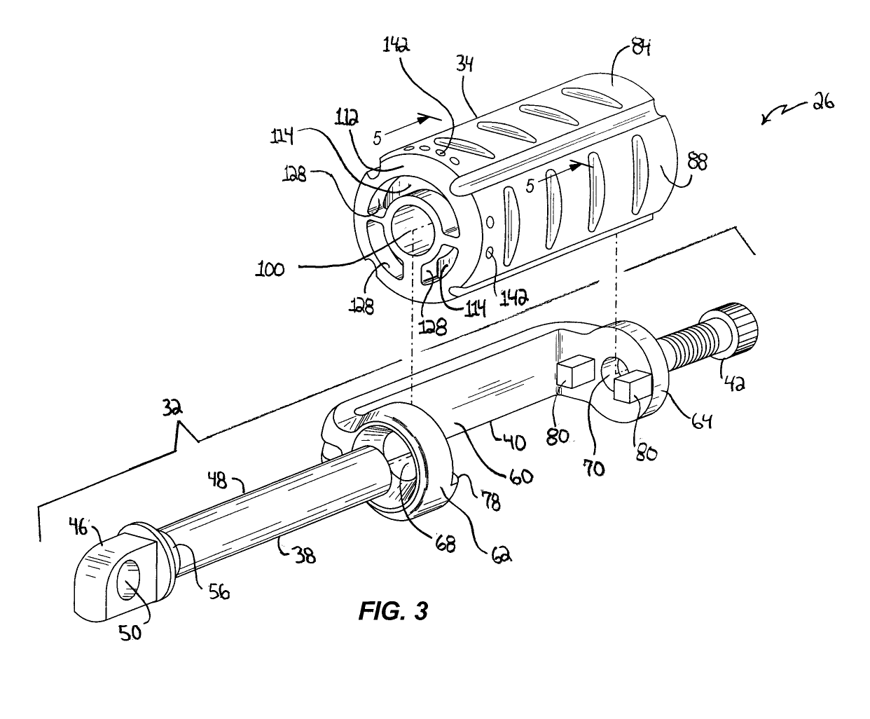

Each of the first and second foot peg assemblies 26, 28 are substantially similar. Therefore, only the first foot peg assembly 26 will be described in detail. Referring to FIGS. 2 and 3, the foot peg assembly 26 includes a mounting bracket 32 and a foot pad 34. The mounting bracket 32 includes a mount 38, a frame 40, and a fastener 42 that couples the frame 40 to the mount 38.

Referring to FIG. 2, the mount 38 includes a motorcycle mounting portion 46 and a foot pad mounting portion 48. The motorcycle mounting portion 46 includes an aperture 50 that receives a fastener, such as a bolt, screw, and the like, to couple the mount 38 to the motorcycle 10 of FIG. 1. The illustrated foot pad mounting portion 48 is generally cylindrical and includes a threaded bore 54 located at an end of the mount 38 that receives the fastener 42. While the illustrated foot pad mounting portion 48 has a generally circular cross-section, it should be understood that in other constructions the cross-section of the foot pad mounting portion can take other shapes. For example, the cross-section of the foot pad mounting portion can be oval, triangular, square, rectangular, hexagonal, octagonal, etc.

A transition portion 56 extends between the motorcycle mounting portion 46 and the foot pad mounting portion 48. The illustrated transition portion 56 is frustoconical in shape such that the transition portion 56 has an outer diameter that decreases from the motorcycle mounting portion 46 toward the foot pad mounting portion 48.

The mount 38 can be formed from any suitable material, such as steel, aluminum, zinc, chrome, composite materials, and the like. Furthermore, the mount 38 can be integrally formed as a single piece or can be made from two or more pieces that are coupled together.

Referring to FIGS. 2 and 3, the frame 40 is generally C-shaped including a central portion 60 extending between two enlarged end portions 62, 64. The first end portion 62 includes a first frame aperture 68 and the second end portion 64 includes a second frame aperture 70. The first frame aperture 68 defines a tapered diameter that decreases in a direction toward the second end portion 64 (see FIG. 3). The second frame aperture 70 has a first portion 72 with a diameter that is sized to receive the shank of the fastener 42, and a second, or counterbored portion 74 that is sized to receive at least a portion of the head of the fastener 42 (FIG. 2). In some embodiments, the head of the fastener is flush with the outer surface of the frame 40.

With continued reference to FIGS. 2 and 3, the end portions 62, 64 of the frame 40 include bosses 78, 80 extending into the interior of the frame 40. The bosses 78 of the first end portion 62 are generally arcuate in shape extending around the first frame aperture 68. Each of the illustrated bosses 78 arcs about 90 degrees around the first frame aperture 68 with a space or gap between the bosses 78. The illustrated bosses 80 of the second end portion 64 are generally cubical in shape and are located approximately 180 degrees from each other around the second frame aperture 70. While the illustrated end portions 62, 64 of the frame 40 each include two bosses 78, 80, in other constructions the end portions can include one or more than two bosses. In yet other constructions, the end portions may omit the bosses.

Referring to FIGS. 2 and 5, the foot peg assembly 26 further includes the foot pad 34. In one construction, the foot pad 34 is formed from a resilient material that is capable of returning to its original shape after the foot pad 34 has been deformed. In one such construction, the resilient material is an elastomer, such as rubber having a Shore A durometer that ranges from about 30 to about 50. In one construction, the rubber can have a Short A durometer that is about 40. In other constructions, the foot pad 34 can be formed from other suitable resilient materials having any suitable durometer. The foot pad 34 can be formed using any suitable method, such as molding, vulcanizing, cutting, casting, etc.

The foot pad 34 has an outer surface that includes four outer surface portions 84, 86, 88, 90 that are defined by grooves 94 that extend longitudinally along the outer surface of the foot pad 34. The illustrated outer surface portions 84, 86, 88, 90 are generally convex and include a plurality of recesses 96 that extend generally normal to the longitudinal grooves 94.

Referring to FIG. 3, the foot pad 34 further includes an aperture 100 that extends longitudinally through the foot pad 34. The illustrated aperture 100 is cylindrical and has an inner diameter sized to receive the foot pad mounting portion 48 of the mount 38.

Referring to FIG. 5, cavities 104, 106, 108 are formed within the foot pad 34, between the aperture 100 and the outer surface of the foot pad 34. When viewed in cross-section, the cavities 104, 106, 108 are arcuate, and the combination of cavities 104, 106, 108 generally forms a circle around the aperture 100. The first arcuate cavity 104 arcs through approximately 180 degrees, and the second and third cavities 106, 108 arc through approximately 90 degrees each. The cavities 104, 106, 108 are open to a first end 112 of the foot pad 34 (see FIG. 3) and extend substantially the entire distance along the foot pad 34. The illustrated cavities are open to the first end 112 of the foot pad 34 to facilitate filling the cavities 104, 106, 108 with a viscoelastic material 114, such as urethane gel, silicon, plastic, rubber, and other materials generally exhibiting both viscous and elastic properties. In one construction, the viscoelastic material 114 is softer than foot pad 34 and has a Shore 00 durometer that ranges from about 35 to about 55. In one construction, the viscoelastic material has a Shore 00 durometer of about 45. The illustrated cavities are not exposed to a second end 18 of the foot pad 34. However, in other embodiments, the cavities 104, 106, 108 could be exposed to the second end 118, the outer surface portions 84, 86, 88, 90, or any combination of locations along the foot pad 34.

The cavities 104, 106, 108 are separated by walls 120, 122, 124. The first wall 120 has a thickness T1, is located between the first and second cavities 104, 106, and extends between the second outer surface portion 86 and the aperture 100. The second wall 122 has a thickness T2 that is greater than the thickness T1, is located between the first and third cavities 104, 108, and extends between the third outer surface portion 88 and the aperture 100. The third wall 124 has a thickness T3 that is greater than the thickness T2 of the second wall 122, is located between the second and third cavities 106, 108, and extends between the fourth outer surface portion 90 and the aperture 100. While the illustrated foot pad 34 includes the three walls 120, 122, 124 that define the three cavities 104, 106, 108, in other constructions, the foot pad can include more or less than three walls to define more or less than three cavities.

Referring to FIGS. 2 and 3, the foot pad 34 further includes boss receiving features 128, 130 formed in the first and second ends 112, 118 of the foot pad 34. The boss receiving features 128 of the first end 112 are defined by the open ends of the cavities 104, 106, 108 and the exposed portions of the viscoelastic material 114. The boss receiving features 128 of the first end 112 are sized to receive bosses 78 of the first end 62 portion of the frame 40. The boss receiving features 130 of the second end 118 of the foot pad 34 are formed within the foot pad 34, and are sized to each receive one of the bosses 80 of the second end portion 64 of the frame 40. It should be understood that FIGS. 2 and 3 illustrate just one possible arrangement of the bosses 128, 130 and the boss receiving features 78, 80, and in other constructions the bosses and boss receiving features can take other shapes in any suitable arrangement. In yet other constructions, the foot pad may omit the boss receiving features.

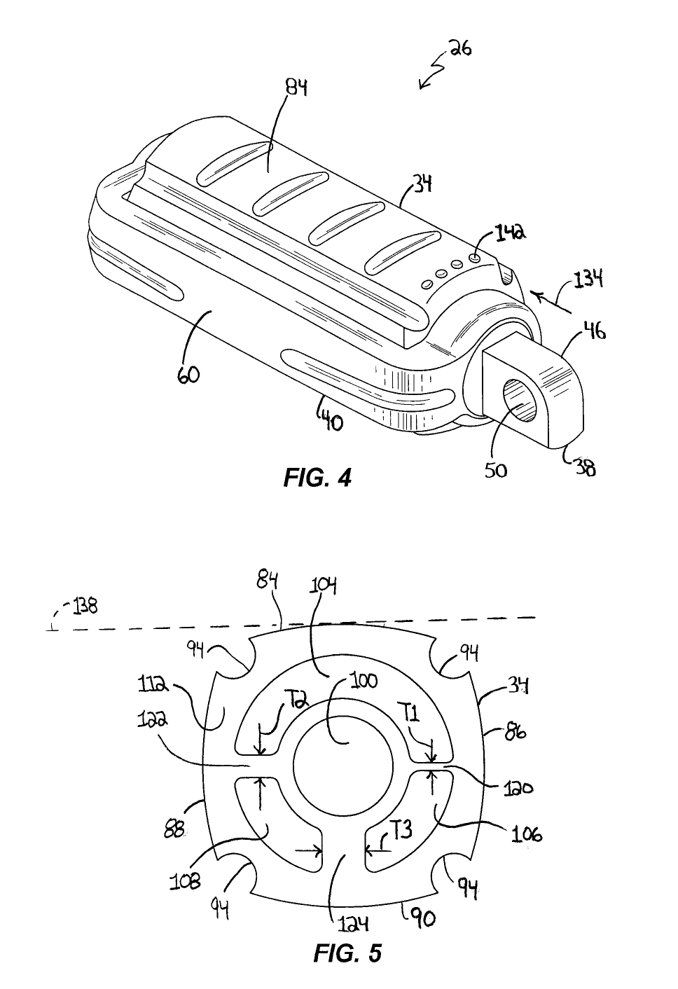

To assemble and couple the foot peg assembly 26 to the motorcycle 10, the mount 38 is coupled to the motorcycle using a fastener positioned through the aperture 50. The foot pad 34 is placed within the interior of the frame 40 such that bosses 78, 80 of the frame 40 engage the boss receiving features 128, 130 of the foot pad 34. The bosses 78, 80 and the boss receiving features 128, 130 are arranged such that any one of the outer surface portions 84, 86, 88, 90 can be generally upwardly facing (FIG. 4). While FIG. 4 illustrates the first outer surface portion 84 generally upwardly facing, the bosses 78, 80 and the boss receiving features 128, 130 are arranged such that any one of the outer surface portions 84, 86, 88, 90 can be generally upwardly facing.

Referring to FIGS. 3 and 4, the mount 38 is inserted through the first frame aperture 68 and through the foot pad aperture 100 such that the frustoconical transition portion 56 of the mount 38 abuts the tapered first frame aperture 68. The tapers of the transition portion 56 and the first flange aperture 68 prevent further movement of the mount 38 with respect to the frame 40 in the direction indicated by an arrow 134 in FIG. 4. In addition, the tapers provide for adjustability such that the orientation of the frame 40 and foot pad 34 can be adjusted about the axis of the mount 38.

Referring to FIGS. 2 and 4, with the foot pad 34, frame 40, and mount 38 in the position as illustrated in FIG. 4, the fastener 42 can be inserted through the second frame aperture 70 and into the threaded bore 54 of the mount 38 to couple the foot pad 34 and the frame 40 to the mount 38.

Referring to FIGS. 1 and 4, in operation, the rider is supported by the seat 20 and rests the bottom of their foot, represented by the dashed line 138 of FIG. 5, on the first outer surface portion 84 of the foot pad 34. The rider operates the motorcycle 10, and as a result vibrations are generated. The vibrations can be generated by the engine 16 and/or features of the riding surface (i.e. bumps, undulations, etc.). The vibrations are transferred to the mount 38, through the foot pad 34, and to the rider's foot. The resilient foot pad 34 that includes the cavities 104, 106, 108 filled with the viscoelastic material 114 dampens the vibrations as they are transferred through the foot pad 34 and to the rider's foot.

Referring to FIG. 5, when the first outer surface portion 84 supports the rider's foot, the foot pad 34 has a first damping characteristic that transfers a first damped amount of the motorcycle vibrations through the foot pad 34 and to the rider's foot. When the second outer surface portion 86 supports the rider's foot, the foot pad 34 has a second damping characteristic that transfers a second damped amount of the motorcycle vibrations through the foot pad 34 and to the rider's foot. The second damping characteristic dampens less motorcycle vibrations than the first damping characteristic because the first wall 120 is located adjacent the second outer surface portion 86 and there is no wall located adjacent the first outer surface potion 84.

Similarly, when the third outer surface portion 88 supports the rider's foot, the foot pad 34 has a third damping characteristic that transfers a third damped amount of the motorcycle vibrations through the foot pad 34 to the rider's foot. The second wall 122 that is adjacent the third outer surface portion 88 has the thickness T2 that is greater than the thickness T1 of the first wall 90. Therefore, the third damping characteristic dampens less of the motorcycle vibrations than the second damping characteristic because of the increased wall thickness T2 which also results in less viscoelastic material between the third outer surface portion 88 and the mount 38 than between the mount 38 and the second outer surface portion 86.

When the fourth outer surface portion 90 supports the rider's foot, the foot pad 34 has a fourth damping characteristic that transfers a fourth damped amount of the motorcycle vibrations through the foot pad 34 to the rider's foot. The third wall 124 has the thickness T3 that is greater than the thickness T2 of the second wall 122, and for the reasons set-forth above with regard to the second and third damping characteristics, the fourth damping characteristic dampens less motorcycle vibrations than the third damping characteristic.

If the rider chooses to change the magnitude of the vibrations that are transferred from the motorcycle 10 to their foot, the rider can adjust the orientation of the foot pad 34 with respect to the motorcycle 10 to place a different outer surface portion of the foot pad 34 in the upwardly facing position. In the illustrated construction, the foot pad 34 is adjusted by rotating the foot pad 34 with respect to the mount 38. To rotate the food pad 34 the rider would first remove the fastener 42 from the bore 54 and the second frame aperture 70. Then, the frame 40 and foot pad 34 are removed from the mount 38 by sliding the frame 40 and foot pad 34 in the direction indicated by the arrow 134 in FIG. 4. Then, the foot pad 34 is uncoupled from the frame 40. The resilient material of the foot pad 34 allows the rider to deflect the foot pad 34 in order to remove the foot pad 34 from within the frame 40. Then, the rider rotates the foot pad 34 to place the desired outer surface portion generally upwardly facing.

Indicia 142 on the outer surface of the foot pad 34 corresponds to the damping characteristic of the outer surface portions 84, 86, 88, 90. Therefore, the rider can use the indicia 142 to identify the outer surface portions 84, 86, 88, 90 with the desired damping characteristic. For example, in the illustrated construction, the indicia 142 includes a series of depressions formed in each of the outer surface portions 84, 86, 88, 90. Four depressions correspond to the first damping characteristic, three depressions correspond to the second damping characteristic, two depressions correspond to the third damping characteristic, and one depression corresponds to the first damping characteristic. Of course, in other constructions the foot pad may include any suitable form of indicia to identify the damping characteristics of the outer surface portions.

When the desired damping characteristic has been chosen, the user re-couples the loot pad 34 to frame 40, such that the desired outer surface portion 84, 86, 88, 90 that corresponds to the desired damping characteristic is generally upwardly facing. The bosses 78, 80 and boss receiving features 128, 130 engage to align the foot pad 34 with respect to the frame 40 and prevent substantial relative rotation between the foot pad 34 and the frame 40. The foot pad 34 and the frame 40 are re-coupled to the mount 38 such that the desired outer surface portion remains substantially upwardly facing. Then, the rider re-inserts the fastener 42 through the second frame aperture 70 and into the bore 54 in order to couple the frame 40 and foot pad 34 to the mount 38.

Thus, the invention provides, among other things, a foot peg assembly 26 for use with a motorcycle. The foot peg assembly 26 includes a foot pad 34 that has cavities 104, 106, 108 filled with a viscoelastic material 114. Furthermore, the foot pad 34 is adjustable a different amount of several damping characteristics, each damping characteristic is adapted to dampen a different amount of motorcycle vibrations through the foot pad 34. Various features and advantages of the invention are set forth in the following claims.

What is claimed is:

1. A foot peg assembly for use with a motorcycle, the foot peg assembly comprising:
a mount adapted to be coupled to the motorcycle; and
a foot pad supported by the mount, the foot pad made from:
a first material and including a cavity formed therein, and
a second material in the cavity different from the first material, wherein the second material is a viscoelastic material.

2. The foot peg assembly of claim 1, wherein the first material is a resilient material.

3. The foot peg assembly of claim 2, wherein the resilient material is rubber.

4. The foot peg assembly of claim 1, wherein the viscoelastic material is a urethane gel.

5. The foot peg assembly of claim 1, wherein the cavity is a first cavity and wherein the foot pad includes a second cavity separated from the first cavity by a first wall having a first thickness.

6. The foot peg assembly of claim 5, wherein the foot pad further includes a third cavity separated from the first cavity by a second wall having a second thickness greater than the first thickness.

7. The foot peg assembly of claim 6, wherein the third cavity is separated from the second cavity by a third wall having a third thickness greater than the first and second thicknesses.

8. A foot peg assembly for use with a motorcycle, the foot peg comprising:
a mount adapted to be coupled to the motorcycle; and
a foot pad supported by the mount, wherein the foot pad is selectively adjustable between a first position corresponding with a first damping characteristic and a second position corresponding with a second damping characteristic different than the first damping characteristic.

9. The foot peg assembly of claim 8, wherein the foot pad is movably coupled to the mount.

10. The foot peg assembly of claim 9, wherein the foot pad is rotatable with respect to the mount between the first and second positions.

11. The foot peg assembly of claim 10, further comprising a frame coupled to the mount, the frame including a boss and the foot pad including a first boss receiving feature adapted to receive the boss when the foot pad is in the first position and a second boss receiving feature adapted to receive the boss when the foot pad is in the second position.

12. The foot peg assembly of claim 8, wherein the foot pad is also selectively adjustable into a third position corresponding with a third damping characteristic different than the first and second damping characteristics.

13. The foot peg assembly of claim 12, wherein the foot pad is also selectively adjustable into a fourth position corresponding with a fourth damping characteristic different than the first, second, and third damping characteristics.

14. The foot peg of claim 8, wherein the first damping characteristic is adapted to transfer a first damped amount of vibrations through the foot pad, and wherein the second damping characteristic is adapted to transfer a second damped amount of vibrations through the foot pad, the second damped amount of vibrations being less than the first damped amount of vibrations.

15. A method of using a foot peg assembly for a motorcycle, the foot peg assembly having a foot pad and a mount, the method comprising:
generating vibrations with the motorcycle;
resting a foot of a rider of the motorcycle on the foot pad;
damping the motorcycle vibrations with the foot pad exhibiting a first damping characteristic;
transferring a first amount of damped vibrations through the foot pad exhibiting the first damping characteristic to the foot;
adjusting the foot pad to exhibit a second damping characteristic different from the first;
damping the motorcycle vibrations with the foot pad exhibiting the second damping characteristic; and
transferring a second amount of damped vibrations through the foot pad exhibiting the second damping characteristic to the foot.

16. The method of claim 15, wherein adjusting the foot pad further includes moving the foot pad with respect to the mount.

17. The method of claim 16, wherein moving the foot pad with respect to the mount further includes rotating the foot pad with respect to the mount.

18. The method of claim 15, further comprising uncoupling a fastener that couples the foot pad to the mount.

19. The method of claim 15, wherein adjusting the foot pad further includes engaging a boss of a frame of the foot peg with a boss receiving feature of the foot pad to align the foot pad with the mount.

20. The method of claim 15, the method further comprising,
adjusting the foot pad to exhibit a third damping characteristic;
damping the motorcycle vibrations with the foot pad exhibiting the third damping characteristic; and
transferring a third amount of damped vibrations through the foot pad exhibiting the third damping characteristic to the foot.

21. The method of claim 20, the method further comprising,
adjusting the foot pad to exhibit a fourth damping characteristic;
damping the motorcycle vibrations with the foot pad exhibiting the fourth damping characteristic; and
transferring a fourth amount of damped vibrations through the foot pad exhibiting the fourth damping characteristic to the foot.
